(19) United States
(12) Patent Application Publication
(10) Pub. No.: US 2019/0005460 A1
(43) Pub. Date: Jan. 3, 2019

(54) Service Appointment System

(71) Applicant: salesforce.com, inc., San Francisco, CA (US)

(72) Inventors: Xin Wang, Fremont, CA (US); Peter CHUNG, Oakland, CA (US); Adrian RAPP, Sausalito, CA (US)

(21) Appl. No.: 15/637,104

(22) Filed: Jun. 29, 2017

(51) Int. Cl. G06Q 10/10; G06F 3/0482

(52) U.S. Cl. CPC G06Q 10/1095; G06F 3/0482

(57) ABSTRACT

Disclosed herein are system, method, and computer program product embodiments for a service appointment system (SAS). An embodiment operates by receiving, via an interface, a request to access a previously set appointment with a field agent, wherein the appointment indicates a time and location where the appointment is to take place. Responsive to the request to access and via the interface, details about the appointment are provided. A request to communicate with the field agent is received. It is determined that the request to communicate satisfies communication threshold. Based on the determination, a bi-directional communication channel between a requester of the appointment and the field agent is provided prior to the field agent arriving to the location of the appointment at the time of the appointment.

### BACKGROUND

Setting up and changing customer service appointments is a time-consuming task that drains business resources and leads to greater customer dissatisfaction. The business must spend time and money to hire and train staff to receive customer calls to set up cancel, reschedule, and send reminders about service appointments. This process is inconvenient for both the customer, who often have to deal with hold times when agents are busy helping other customers, and for customer service agents who could be handling other business issues.

### BRIEF DESCRIPTION OF THE DRAWINGS

The accompanying drawings are incorporated herein and form a part of the specification.

FIG. 1 is a block diagram 100 showing example operations for service appointment system (SAS), according to some embodiments.

FIGS. 2A and 2B are block diagrams showing example operations related to scheduling a customer service appointment using service appointment system (SAS), according to some embodiments.

FIG. 3 is a block diagram showing example operations for service appointment system (SAS), according to some embodiments.

FIG. 4 is a flowchart illustrating a process a service appointment system (SAS), according to some embodiments.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for a service appointment system.

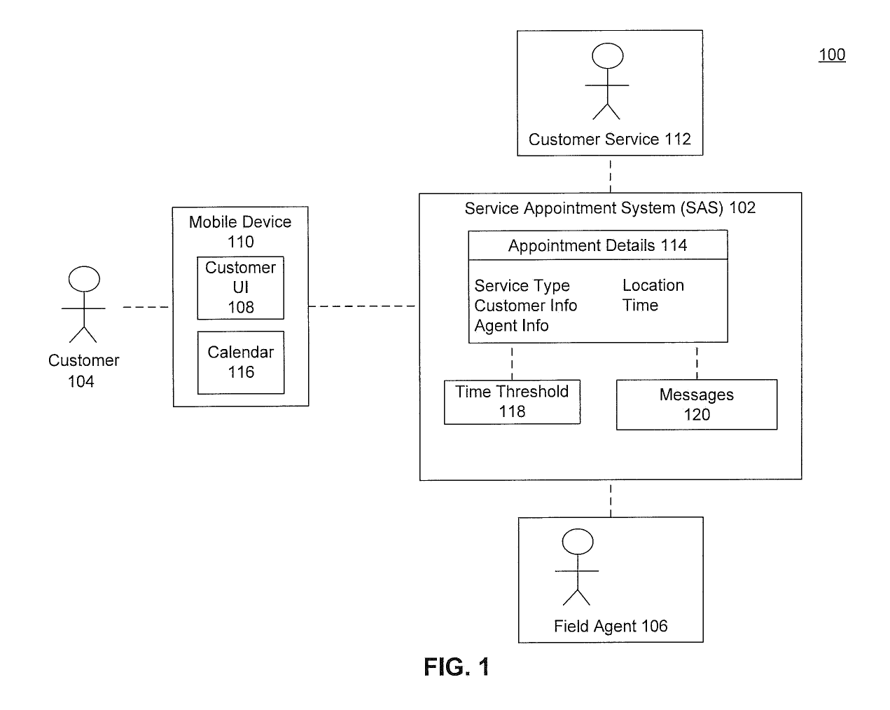

FIG. 1 is a block diagram 100 showing example operations for service appointment system (SAS) 102, according to some embodiments. SAS 102 may enable a customer 104 to set up an appointment with a field agent 106 to perform some type of service for customer 104. Example services include coming to customer's home or business and assembling furniture, setting up electronic devices or systems, fixing appliances, addressing plumbing issues, providing home medical care, or performing any other service. As just noted, the service may occur at a location (or across a plurality of locations) of customer's choosing. The location may be the customer's home, business, or other location requiring customer 104 and/or field agent 106 to travel to meet to render whatever service is being requested.

SAS 102 provides a user interface 108 accessible to customer 104 via their mobile device 110. Mobile device 110 may include any computing device, such as cell phone, laptop, desktop, smart television, or vehicle. Using customer user interface (UI) 108, customer 104 may set up, check the status of, receive reminders for, and modify an appointment with field agent 106.

As will be described in greater detail below, customer UI 108 may also provide for interactive, bi-directional communication or messaging (120) between customer 104 and field agent 106 before, during, and/or after the service appointment, and provide status updates as the appointment time nears. Customer UI 108 may also provide an interface or messaging (120) between customer 104 and customer service 112. Customer service 112 may be one or more agents who may be working at the same or related company as field agent 106 but who may not personally be rendering the service. Example customer service 112 agents include service managers, specially trained customer service agents, human resource coordinators, or even other field agents 106.

In an embodiment, SAS 102 may manage information about the appointment as appointment details 114. Appointment details 114 may include a data stored in a data structure such as a table or row of a database, data in a flat file, or other information stored across one or more data structures, including a cloud computing environment.

Appointment details 114 may include a service type. The service type may indicate a description or indicator of the type of service to be rendered by field agent 106. For example, if customer 104 wants an appliance fixed, the type may indicate what type of appliance (fridge, microwave, Wi-Fi router, etc.) is to be serviced. The type may also or alternatively include relevant details regarding the make, model, number, and description of the problem. An example service type may indicate that the service is to fix an air conditioning unit, which is located in the basement of the house, which is not turning on.

Customer information may indicate the name of the customer, a relevant service plan number associated with the customer, previous appointments or customer service history regarding this particular service or appliance and/or other past services requested by customer 104. The customer information may include other customer-centric details such as indications whether the customer has a pet, an alarm, handicaps or special circumstances about which field agent 106 may need to be aware prior the appointment. For example, if the appointment is to set up a satellite dish on the customer's roof, the customer information may include a minimum ladder size, or an indication as to how many stories the customer's house stands.

Agent information may indicate which field agent 106 has been assigned to the appointment, along with any relevant agent information. Example agent information may include name, service history, agent ranking, experience level, cost or salary, home base location, on-time percentage, or other agent information.

Location may indicate an address or other indication as to the location of the service appointment (e.g., office building, townhome, etc.). Time may indicate a date and time of the appointment.

Rather than calling customer service 112 to speak to an agent (e.g., 112) to try and arrange an appointment for a service request, customer UI 108 may enable customer 104 to directly, and without interaction with a customer service agent 112, schedule or request a service appointment. SAS 102 may then assign a field agent 106 to service the request and maintain details 114 about the appointment throughout the lifetime of the service request, allowing customer 104 real-time, anywhere access to appointment details 114 via customer UI 108.

In an embodiment, customer 104 may select a service type for an appointment, and SAS 102 may retrieve details about the availability or calendar from one or more field agents 106 who are available to fulfill the service request. Customer 104 may then select which appointment time is most convenient and the appointment time may be added to a customer calendar 116. Calendar 116 may include a calendar application, app, or web program that customer 104 uses to schedule appointments. When customer 104 schedules an appointment using customer UI 108, customer 104 may be provided the option of having the appointment be added to calendar 116.

In an embodiment, SAS 102 may request or otherwise have access to calendar 116. Then, for example, when customer 104 is booking or wants to reschedule the appointment, SAS 102 may automatically coordinate the customer's schedule based on calendar 116 with the schedules of one or more field agents 106 who can service the appointment, and provide the available times that satisfy both schedules to customer 104.

In an embodiment, SAS 102 may include a time threshold indicator 118. Time threshold 118 may indicate what information is displayed and/or what functions are available via customer UI 108 depending on how much time remains between a current time and the appointment time or a current status of appointment (e.g., before the appointment, in-progress, completed). As the time until the appointment changes, what information customer 104 sees and what functions are available to customer via customer UI 108 may change.

For example, if time threshold 118 indicates more than one week remains until the appointment time, then customer UI 108 may show the appointment time and allow the customer 104 to reschedule the appointment. However the customer 104 may not contact field agent 106 (field agent 106 may not yet even be assigned). In an embodiment, if less than 48 hours remain until appointment (as indicated by time threshold 118) the ability to reschedule appointment using customer UI may be disabled. Or, for example, customer 104 may be required to pay a rescheduling or cancellation fee to reschedule via customer UI 108, or may have to call and speak to a customer service agent 110.

In an embodiment, customer 104 may be required to perform some action prior to the appointment, such as resetting their circuit breaker, turning a device off, etc. Then, for example, when such a threshold 118 is satisfied, customer 108 may provide that information or a notification to customer 104 to perform the action and confirm that it has been performed. In an embodiment, if customer 104 does not confirm that the action has been performed, SAS 102 may reschedule and/or notify customer 104 that the appointment will be rescheduled because customer 104 failed to perform the recommended within the required time threshold 118.

If less than three hours remain until the appointment, then SAS 012 may provide access to real-time tracking of a field agent 106 via customer UI 108. In an embodiment, rather than determining what functions or display to provide via customer UI 108 based on time, the determination (e.g., time threshold 118) may be based on a status of the appointment (e.g., whether field agent 106 has left for appointment). Once the appointment has started, customer UI 108 may provide an appointment timer or allow customer 104 to enter notes about the service request. Upon a completion of the appointment, customer UI 108 may provide access to the customer 104 with any completion documents, and allow customer 104 to rate the service request.

In an embodiment, customer UI 108 may enable direct, bi-directional communication 120 between customer 104 and field agent 106 and/or a customer service agent 112, or a chat/messaging (120) between all three parties. For example, prior to an appointment, once a particular field agent 106 has been assigned, a customer 104 may send messages 120 to field agent 106, and vice versa. This may enable for a smoother servicing of the appointment, and provide value to customer 104. Customer 104 may also request a chat with a customer service agent 112. Unlike field agent 106 chats which may be limited until X hours before the appointment time (as determined by time threshold 118), customer 104 may be able to chat with customer service 112 any time before, during, or after an appointment. In an embodiment, the chat details (including a transcript of the chats) may be saved as messages 120.

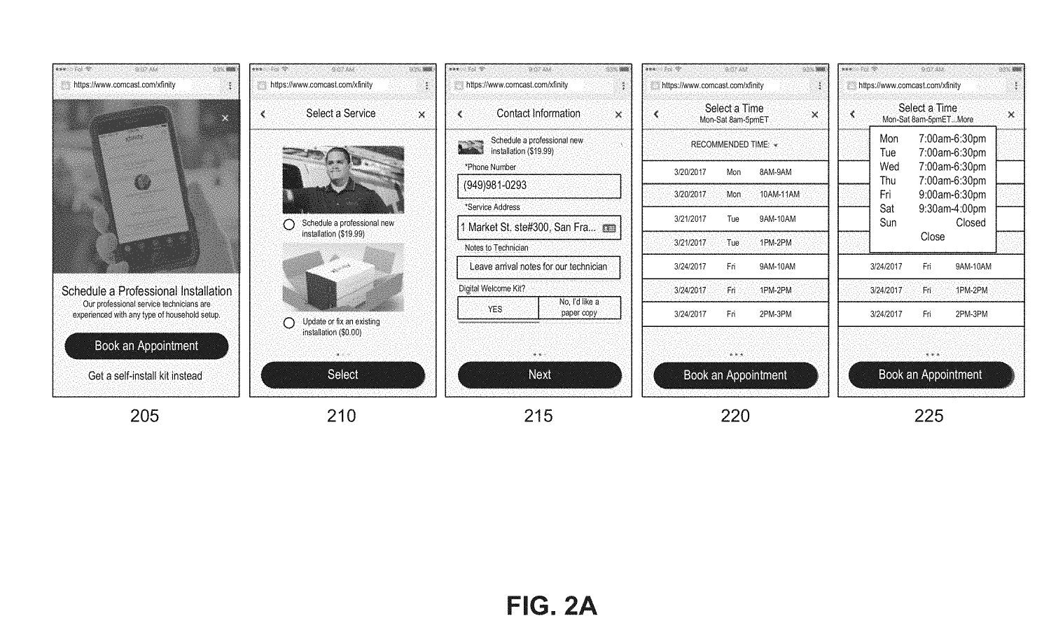

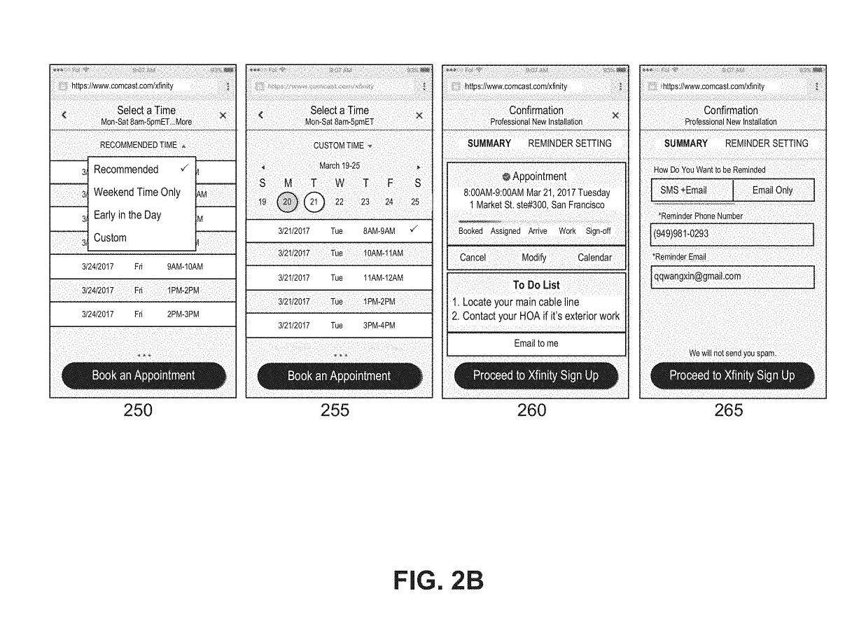

FIGS. 2A and 2B are block diagrams showing example operations related to scheduling a customer service appointment using service appointment system (SAS) 102, according to some embodiments. FIGS. 2A and 2B show example customer user interfaces 108 as SAS 102 prompts or walks customer 104 through booking a service appointment, however it is understood that a similar procedure could be followed when rescheduling a service appointment as well.

At 205, a customer 104 may choose between booking a service appointment or requesting a self-install or self-service kit or instructions which may enable customer 104 to solve the problem or service issue without a field agent 106.

At 210, a customer 104 may have selected to book an appointment (205) and may be presented with a variety of different service types from which to choose. As shown, different service types may have different requirements or preconditions, such as cost.

At 215, customer UI 108 may receive or ask customer to verify customer information. For example, customer 104 may be a returning customer with an existing account, then at 215 the customer information may be retrieved and displayed (including the location of the appointment) for confirmation by customer 104. Or, for example, customer 104 may be prompted to enter required and/or optional information as shown. In an embodiment, customer location information may be requested or retrieved directly from mobile device 110 (which may have a GPS unit or other location indicator). In an embodiment, customer 104 may select whether to receive information regarding the service appointment digitally or in tangible paper form.

At 220, SAS 102 may display a variety of different date/time combinations during which one or more field agents 106 qualified to service the requested appointment are available. In an embodiment, SAS 102 may have or request access to calendar 116 of the customer 104 and may only show those appointments that are convenient both for customer 104 (based on calendar 116) and one or more field agents 106.

At 225, a user or customer 104 may scroll and try to select additional or alternative times other than just the recommended times shown in 220.

In FIG. 2B, at 250, customer 104 may be provided with general time frames during which customer 104 may prefer to schedule an appointment. The examples shown, include recommended times (shown in 220), weekend only, early in the day, or custom. Custom may include any user specified parameters for a particular time frame, such as only showing particular dates based on coordinating with calendar 116.

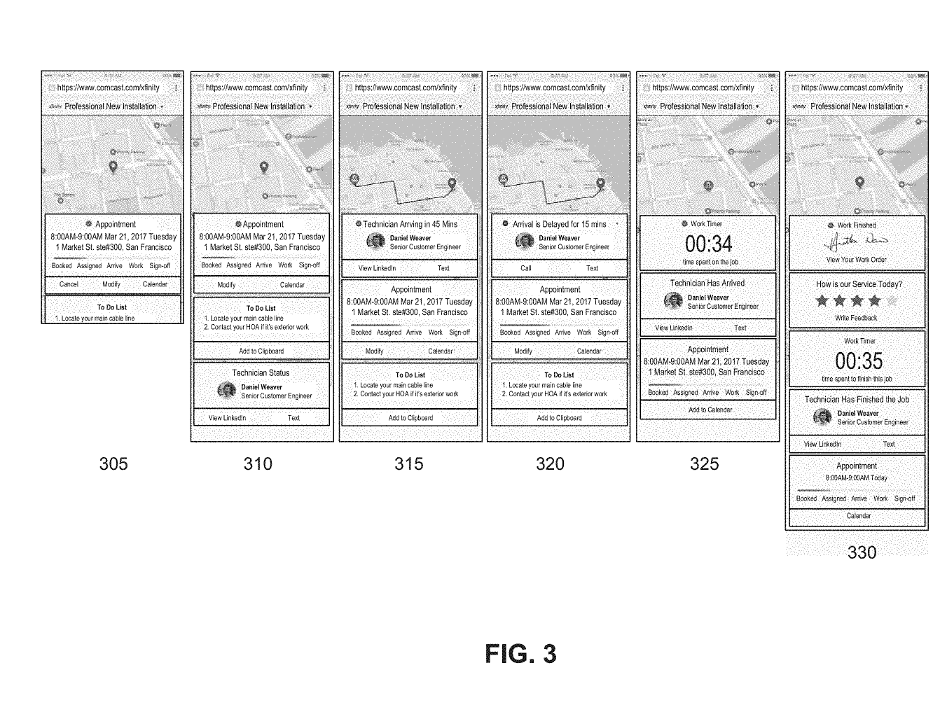

At 255, customer 104 may select a particular date and time for the requested appointment. At 260, SAS 102 may provide an appointment card confirming details about the scheduled service appointment (as described in further detail below with regard to FIG. 3, the appointment card may be updated based on time threshold 118).

At 260, customer 108 may also provide customer 104 with various functionality that may be performed related to the service appointment. The functionality shown includes cancelling or modifying the appointment. In an embodiment, SAS 102 may provide user a list of instructions or to-do items for the customer 104 to perform prior to the scheduled appointment. In an embodiment, the customer 104 has the option of sharing the appointment details by sending an email to someone or a text or calendar appointment.

At 265, customer 104 may configure reminder settings. In the example shown, the customer 104 may request and/or schedule e-mail or text reminders for the scheduled appointment. In an embodiment, customer 104 may request that a reminder be provided 48 hours, 24 hours, or 3 hours (or another specified time period) before the scheduled appointment time.

FIG. 3 is a block diagram showing example operations for service appointment system (SAS) 102, according to some embodiments. The example interfaces (108) shown in FIG. 3 show how SAS 102 may change what information and functionality are available via customer UI 108 based on time threshold 118.

At 305, customer UI 108 may display a date, time, and location of the appointment, and may enable customer 104 to modify or cancel the appointment.

At 310, customer 108 may be notified via mobile device 110 that the appointment details have been updated. For example, a technician or field agent 106 may be assigned. At this point, though not specifically shown, SAS 102 may enable messaging 120 between customer 104 and field agent 106. In an embodiment, once an agent 106 is assigned, the user may no longer be provided the option of cancelling the appointment.

When the time until appointment time drops below an hour (e.g., time threshold 118 or other status indication), customer UI 108 may show real-time status updates as shown in 315 and 320. In an embodiment, the estimated arrival time may account for traffic and weather delays. In an embodiment, the agent 106 real-time location may be received from a mobile device of the field agent 106. In an embodiment, a customer 104 may optionally share his/her location with field agent 106 as well. For example, if customer 104 has not yet arrived at the appointment location, knowing the customer location information (as may be determined from mobile device 11) may be helpful.

At 325, when the appointment is in progress (time threshold 118) customer UI 108 may display a work timer or other information related to the service appointment. 330 shows an example post-appointment-completion interface that shows a length of appointment. The post appointment interface may also include any notes documented by the field agent 106. Customer 104 may be provided the ability to rate the field agent 106 or service request, and may enable customer 104 to sign and/or view any work-related documents.

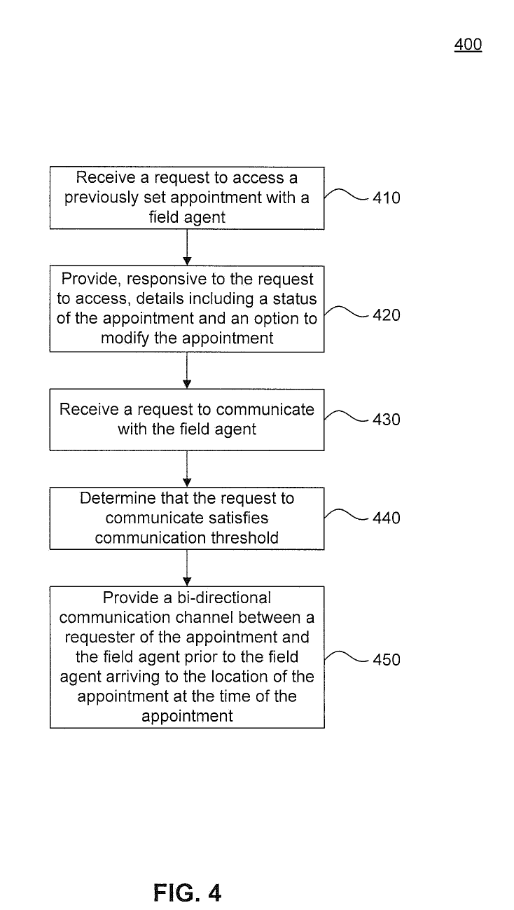

FIG. 4 is a flowchart illustrating a process 400 a service appointment system (SAS), according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

At 410, a request to access a previously set appointment with a field agent is received. For example, customer 104 may request through customer UI 108 appointment details 114. SAS 102 may provide details 114 via an appointment card (260) including both a time and location of the appointment.

At 420, details including a status of the appointment and an option to modify the appointment are provided responsive to the request to access. For example, as shown in 305, customer 104 may be able to cancel or modify the appointment.

At 430, a request to communicate with the field agent is received. For example, in 310 once an agent 106 has been assigned, SAS 102 may receive a message 120 request from customer 104 to message field agent 106. In an embodiment, SAS 102 may allow field agent 106 to initiate messaging 120 with customer 104.

At 440, it is determine that the request to communicate satisfies communication threshold. For example, time threshold 118 may indicate that messaging 120 with field agent 106 (by customer 104) may only occur within 48 hours of the scheduled appointment time. However, customer 104 may be able to message a customer service agent 112 anytime. In an embodiment, the message 120 between agent 106 and customer 104 may be disabled when the appointment is in progress, has completed, or after a specified time threshold 118 after the completion of the appointment (e.g., such as 24 hours).

At 450, a bi-directional communication channel between a requester of the appointment and the field agent is provided prior to the field agent arriving to the location of the appointment at the time of the appointment. For example, SAS 102 may provide messaging capabilities 120 between customer UI 108 and field agent. In an embodiment, the messages 120 may be received as SMS messages, e-mail messages, or other notifications on a mobile device 110 of customer 104 and field agent 106.

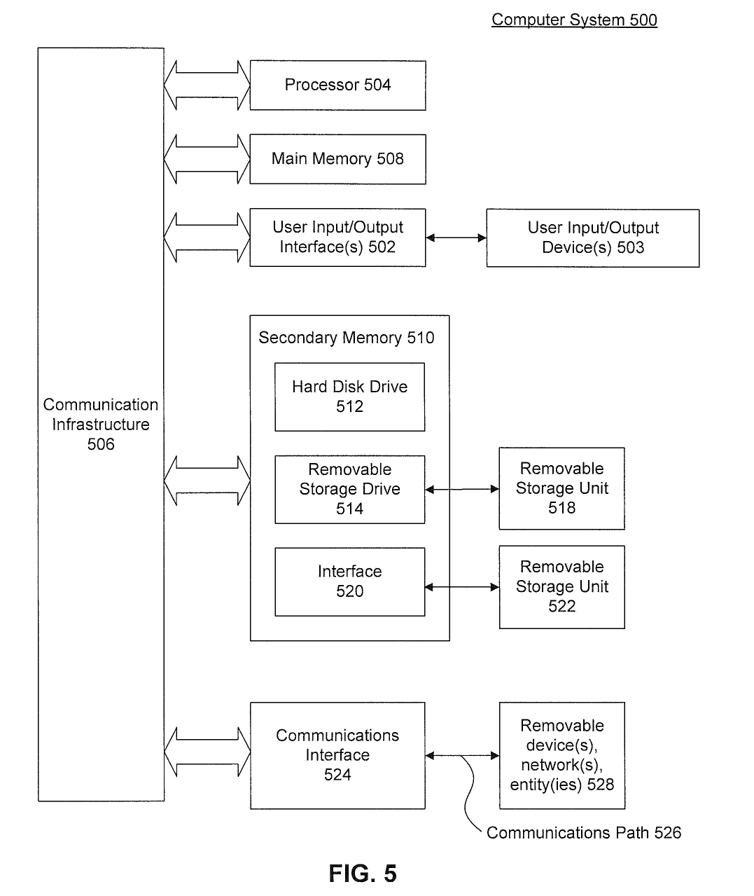

Various embodiments can be implemented, for example, using one or more computer systems, such as computer system 500 shown in FIG. 5. Computer system 500 can be used, for example, to implement the systems described above with respect to the figures, and/or the method of FIG. 4. Computer system 500 can be any computer capable of performing the functions described herein.

Computer system 500 can be any well-known computer capable of performing the functions described herein.

Computer system 500 includes one or more processors (also called central processing units, or CPUs), such as a processor 504. Processor 504 is connected to a communication infrastructure or bus 506.

One or more processors 504 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 also includes user input/output device(s) 503, such as monitors, keyboards, pointing devices, etc., that communicate with communication infrastructure 506 through user input/output interface(s) 502.

Computer system 500 also includes a main or primary memory 508, such as random access memory (RAM). Main memory 508 may include one or more levels of cache. Main memory 508 has stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to an exemplary embodiment, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

In an embodiment, a tangible apparatus or article of manufacture comprising a tangible computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving, via an interface, a request to access a previously set appointment with a field agent, wherein the appointment indicates a time and location where the appointment is to take place;
providing, responsive to the request to access and via the interface, details about the appointment, the details including a status of the appointment and an option to modify the appointment;
receiving a request to communicate with the field agent;
determining that the request to communicate satisfies communication threshold; and
providing, based on the determination and via the interface, a bi-directional communication channel between a requester of the appointment and the field agent prior to the field agent arriving to the location of the appointment at the time of the appointment.

2. The method of claim 1, wherein the providing a bi-directional communication channel comprises:
providing a bi-directional communication channel between a customer service agent of a company associated with the field agent and a requester from whom the request is received.

3. The method of claim 2, wherein the providing a bi-directional communication channel comprises:
providing a communication channel between the customer service agent, the field agent, and the requester.

4. The method of claim 1, wherein providing the details comprises:
determining a difference between a current time and the time of the appointment; and
providing the details based on the difference.

5. The method of claim 4, wherein the providing the details based on the difference comprises:
determining that the difference exceeds a threshold, wherein the threshold indicates a minimum time until the appointment; and
providing details about the appointment, including a location of the field agent relative to the location of the appointment.

6. The method of claim 4, wherein the providing the details based on the difference comprises:
determining that the difference exceeds a threshold, wherein the threshold indicates that the appointment is in progress; and
providing details about a progress of the appointment, including a counter indicating a length of the appointment since the field service agent began service.

7. The method of claim 1, wherein the determining comprises:
determining that the request is to reschedule the appointment time;
receiving one or more available appointment times associated with a requester;
determining one or more available appointment times associated with the field service agent;
comparing the appointment times of the requester with the appointment times of the field service agent; and
providing one or more overlapping appointment times that indicate that both the requester and the field service agent are available to reschedule the appointment.

8. A system, comprising:
a memory; and
at least one processor coupled to the memory and configured to:
receive, via an interface, a request to access a previously set appointment with a field agent, wherein the appointment indicates a time and location where the appointment is to take place;
provide, responsive to the request to access and via the interface, details about the appointment, the details including a status of the appointment and an option to modify the appointment;
receive a request to communicate with the field agent;
determine that the request to communicate satisfies communication threshold; and
provide, based on the determination and via the interface, a bi-directional communication channel between a requester of the appointment and the field agent prior to the field agent arriving to the location of the appointment at the time of the appointment.

9. The system of claim 8, wherein the processor configured to provide a bi-directional communication channel is configured to:
provide a bi-directional communication channel between a customer service agent of a company associated with the field agent and a requester from whom the request is received.

10. The system of claim 9, wherein the processor configured to provide a bi-directional communication channel is configured to:
provide a communication channel between the customer service agent, the field agent, and the requester.

11. The system of claim 8, wherein the processor configured to provide the details is configured to:
determine a difference between a current time and the time of the appointment; and
provide the details based on the difference.

12. The system of claim 11, wherein the processor configured to provide the details based on the difference is configured to:
determine that the difference exceeds a threshold, wherein the threshold indicates a minimum time until the appointment; and
provide details about the appointment, including a location of the field agent relative to the location of the appointment.

13. The system of claim 11, wherein the processor configured to provide the details based on the difference is configured to:
determine that the difference exceeds a threshold, wherein the threshold indicates that the appointment is in progress; and
provide details about a progress of the appointment, including a counter indicating a length of the appointment since the field service agent began service.

14. A non-transitory computer-readable device having instructions stored on a memory thereon that when executed by at least one processor of the device, causes the at least one processor to perform operations comprising:
receiving, via an interface, a request to access a previously set appointment with a field agent, wherein the appointment indicates a time and location where the appointment is to take place;
providing, responsive to the request to access and via the interface, details about the appointment, the details including a status of the appointment and an option to modify the appointment;
receiving a request to communicate with the field agent;
determining that the request to communicate satisfies communication threshold; and
providing, based on the determination and via the interface, a bi-directional communication channel between a requester of the appointment and the field agent prior to the field agent arriving to the location of the appointment at the time of the appointment.

15. The device of claim 14, wherein the operations for providing a bi-directional communication channel comprise:
providing a bi-directional communication channel between a customer service agent of a company associated with the field agent and a requester from whom the request is received.

16. The device of claim 15, wherein the operations for providing a bi-directional communication channel comprises:
providing a communication channel between the customer service agent, the field agent, and the requester.

17. The device of claim 14, wherein the operations for providing the details comprise:
determining a difference between a current time and the time of the appointment; and
providing the details based on the difference.

18. The device of claim 17, wherein the operations for providing the details based on the difference comprise:
determining that the difference exceeds a threshold, wherein the threshold indicates a minimum time until the appointment; and
providing details about the appointment, including a location of the field agent relative to the location of the appointment.

19. The device of claim 17, wherein the operations for providing the details based on the difference comprise:
determining that the difference exceeds a threshold, wherein the threshold indicates that the appointment is in progress; and
providing details about a progress of the appointment, including a counter indicating a length of the appointment since the field service agent began service.

20. The device of claim 14, wherein the operations for determining comprise:
determining that the request is to reschedule the appointment time;
receiving one or more available appointment times associated with a requester;
determining one or more available appointment times associated with the field service agent;
comparing the appointment times of the requester with the appointment times of the field service agent; and
providing one or more overlapping appointment times that indicate that both the requester and the field service agent are available to reschedule the appointment.
